(19) United States
(12) Patent Application Publication
(10) Pub. No.: US 2026/0074598 A1
(43) Pub. Date: Mar. 12, 2026

(54) LINEAR ACTUATOR, CONTROL METHOD, AND STORAGE MEDIUM

(71) Applicant: CANON KABUSHIKI KAISHA, Tokyo (JP)

(72) Inventor: KOUHEI EGUCHI, Kanagawa (JP)

(21) Appl. No.: 19/316,349

(22) Filed: Sep. 2, 2025

(30) Foreign Application Priority Data
Sep. 11, 2024 (JP) 2024-157497

(51) Int. Cl. H02K 41/03

(52) U.S. Cl. CPC H02K 41/03

(57) ABSTRACT

A linear actuator includes a multipolar magnet in which a plurality of magnets are arranged in an arrangement direction; a coil body in which two or more coils are bound; a sensor detecting a relative position between the coil body and the multipolar magnet; and a current-supply controller controlling currents supplied to the coils of the coil body on the basis of the relative position detected by the sensor. The coil body and the multipolar magnet are relatively movable with respect to each other in the arrangement direction. The current-supply controller performs the control such that a phase difference between a magnetic phase of the multipolar magnet and a current-supply phase to the coil body is within a predetermined range, and the phase difference transitions in a time series.

### BACKGROUND

### Field of the Technology

The present disclosure relates to a linear actuator, a control method, a storage medium, and the like.

### Description of the Related Art

An electromagnetic linear motor can be configured to move linearly in a noncontact manner and can realize excellent characteristics in silence, durability, minute movement, and the like in comparison with a linear drive device based on a combination of another rotary motor and a power conversion mechanism or friction. Accordingly, such electromagnetic linear motors are used in various fields.

Electromagnetic linear motors can be classified into a synchronization type using an interaction force between magnetic poles, an induction type using Lorentz force, and a direct-current type according to driving principles thereof. Among these, a direct-current type linear DC motor (LDM) uses a Lorentz force which is generated substantially in proportion to a current flowing in a coil as a direct driving force.

Accordingly, an LDM can generally control a small force and can be suitably used for precise positioning. Accordingly, the LDM is used, for example, as a lens driving unit in an optical device such as a camera, a reading head driving unit such as a hard disk drive (HDD), or an industrial carrier device. The LDM is also referred to as a linear actuator on the basis of the drive principle or applications thereof.

Linear actuators can be additionally classified into a monopolar type and a multipolar type of magnetic poles according to a configuration of a magnetic field portion. This classification is based on whether a direction of a magnetic field acting on the same part of a coil in a stroke range of a linear actuator is constant or periodically changes. The multipolar type in the latter is generally configured by alternately connecting a plurality of magnets such as permanent magnets.

In general, a monopolar linear actuator has a simple configuration and has advantages that thrust ripples do not occur in principle. On the other hand, a monopolar linear actuator has disadvantages that a stroke range in which a large thrust can be generated is narrow due to limitation of the permeance of a magnet, magnetization saturation of a yoke, or the like.

On the other hand, a multipolar linear actuator has disadvantages that the configuration thereof is likely to be complicated and thrust ripples are likely to occur. However, a multipolar linear actuator has advantages that an influence of the permeance of a magnet, magnetization saturation of a yoke, or the like can be easily avoided and a stroke range can be easily enlarged. Accordingly, such linear actuators are selectively used according to applications thereof.

For example, such linear actuators are used as lens drive devices for realizing an automatic focusing function or an image stabilization function in a camera which is one application example of a linear actuator.

Here, since a necessary movement range of a lens group is limited, monopolar linear actuators have often been used in the related art. However, in recent years, there has been increasing demand for enlarging the movement range, leading to increasing use of multipolar linear actuators.

In cameras, disturbance which occurs while a linear actuator is static or driven due to a change in posture of a camera by a user or due to driving of a member such as a shutter by a user badly affects static position accuracy or constant-speed driving. Accordingly, there are needs for a control system which is resistant to disturbance even in driving of a multipolar linear actuator.

Japanese Patent No. 7347548 discloses a configuration of a multipolar linear actuator in which magnets with the same poles facing each other are surrounded by coils which are a rotor. Japanese Patent No. 5515310 discloses a configuration including a multipolar magnet in which an S pole and an N pole are alternately arranged and a movable coil body into which a plurality of unit coils are arranged and unified.

In the technique disclosed in Japanese Patent No. 7347548, only a magnitude of a thrust at the time of linear movement is considered, and it is difficult to efficiently perform maintenance of high precision of a static position, constant-speed driving, or the like when disturbance occurs.

In the technique disclosed in Japanese Patent No. 5515310, maintenance can be performed by supplying currents in the same direction to all coils and a static position can be maintained with high precision even when disturbance occurs, but there are problems in that no measures are taken for constant-speed driving.

### SUMMARY

A linear actuator according to an embodiment of the present disclosure includes: a multipolar magnet in which a plurality of magnets are arranged in an arrangement direction; a coil body in which two or more coils are bound; a sensor detecting a relative position between the coil body and the multipolar magnet; and a current-supply controller controlling currents supplied to the coils of the coil body on the basis of the relative position detected by the sensor. The coil body and the multipolar magnet are relatively movable with respect to each other in the arrangement direction. The current-supply controller performs the control such that a phase difference between a magnetic phase of the multipolar magnet and a current-supply phase to the coil body is within a predetermined range, and the phase difference transitions in a time series.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an example of a camera system using an interchangeable lens including a linear actuator according to a first embodiment of the present disclosure.

FIG. 2 is an exploded perspective view of the interchangeable lens 20 including the linear actuator according to the first embodiment.

FIGS. 3A to 3C are schematic diagrams illustrating a configuration of the linear actuator 100 according to the first embodiment.

FIG. 4 is a diagram illustrating magnetic flux in a magnetic field portion 120 of the linear actuator 100 according to the first embodiment.

FIG. 5 is a diagram illustrating an example of a coil current-supply control method for generating a thrust in the linear actuator 100.

FIG. 6 is a diagram illustrating a coil current-supply control method for generating a holding force acting in a direction perpendicular to an optical axis 1a in the linear actuator 100 according to the first embodiment.

FIG. 7 is a diagram illustrating proportions of a thrust and a holding force which are generated according to a current-supply phase to coils in a method of controlling the linear actuator according to the first embodiment.

FIG. 8 is a diagram illustrating an example of time-series transition of a current-supply phase to coils for position holding according to the first embodiment.

### DESCRIPTION OF THE EMBODIMENTS

Hereinafter, embodiments of the present disclosure will be described with reference to the accompanying drawings. The present disclosure is not limited to the following embodiments. In the drawings, the same members or elements will be referred to by the same reference signs, and repeated description thereof will be omitted or simplified.

### First Embodiment

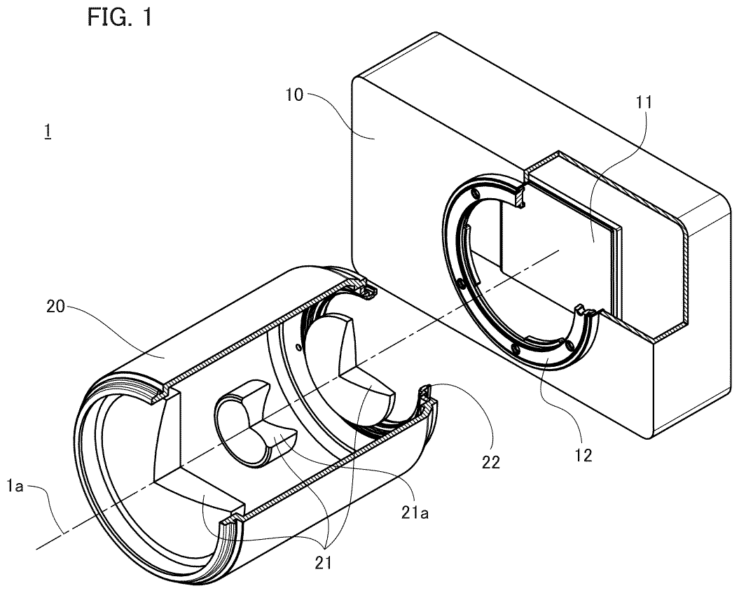

FIG. 1 is a perspective view illustrating an example of a camera system 1 using an interchangeable lens including a linear actuator according to a first embodiment of the present disclosure. In FIG. 1, reference sign 10 denotes a camera body, and reference sign 20 denotes an interchangeable lens.

Reference sign 1a denotes an optical axis of the camera system 1, reference sign 11 denotes an image sensor, reference sign 12 denotes a mount component on a camera body 10 side, reference sign 21 denotes a part of a lens group, 21a denotes a part of a focus lens group in the lens group 21, and reference sign 22 denotes a mount component on the interchangeable lens 20 side.

The camera system 1 is a system for capturing a still image or a moving image and mainly includes a combination of a camera body 10 and an interchangeable lens 20. An image sensor 11 having an imaging function or the like is provided in the camera body 10, and a lens group 21 having a light condensing function or the like is provided in the interchangeable lens 20.

The camera body 10 and the interchangeable lens 20 are strongly coupled to be easily attachable and detachable by causing the mount components 12 and 22 to engage with each other using a structure such as a bayonet.

In this state, the image sensor 11 in the camera body 10 is disposed in the camera body 10 with a position and posture with which an imaging surface thereof is substantially perpendicular to the optical axis 1a of the camera system 1 in the vicinity of the center thereof. The lens group 21 in the interchangeable lens 20 is disposed in the interchangeable lens 20 with a position and posture in which an optical axis thereof is substantially parallel to the optical axis 1a of the camera system 1.

In the camera system 1, a light beam from a subject passes through the interchangeable lens 20, is condensed by the lens group 21, and is focused on the imaging surface of the image sensor 11 of the camera body 10.

In the image sensor 11, photoelectric conversion is performed, and information of the subject light beam is converted to an electrical signal. Image data of a still image or a moving image is acquired by performing various processes on the electrical signal in the camera body 10, and the image data is stored in a nonvolatile memory means in the camera body 10.

Here, control of an exposure time in the camera system 1 is performed through on/off control of a shutter mechanism (not illustrated) provided in the camera body 10 or the interchangeable lens 20 or accumulation time control in the image sensor 11.

Accordingly, an image with appropriate brightness (exposure) can be captured for a subject with various types of brightness. Exposure can be adjusted in the same way through on/off control of an aperture mechanism (not illustrated) in the interchangeable lens 20 and sensitivity (ISO sensitivity, gain) control of photoelectric conversion in the image sensor 11.

The camera system 1 includes a focus lens group 21a having a focus adjusting function in the lens group 21 to cope with imaging of a subject in a broad distance range of from a relatively short distance to an infinite distance.

The camera system 1 can perform imaging with a focus on a subject by detecting subject distance information using a subject distance detecting means which is not illustrated and controlling movement of the focus lens group 21a in the direction of the optical axis 1a according to the information.

Alternatively, an imager can perform imaging with a focus on a subject by observing the subject and estimating a distance via a finder which is not illustrated and performing an operation of moving the focus lens group 21a in the direction of the optical axis 1a.

In the present embodiment, the linear actuator according to the present embodiment is provided in the interchangeable lens 20 and used as a driving means for controlling and performing movement of the focus lens group 21a. In the present embodiment, the camera system 1 including the camera body 10 and the interchangeable lens 20 is shown, and the linear actuator according to the present embodiment can be applied to a camera system with another configuration.

For example, the linear actuator according to the present embodiment can be applied to a camera in which a body and a lens are unified, a camera module with a module configuration for various information communication devices, or the like. The linear actuator according to the present embodiment is not limited to an automatic focusing function and the linear actuator according to the present embodiment can be used, for example, to drive a zoom lens group.

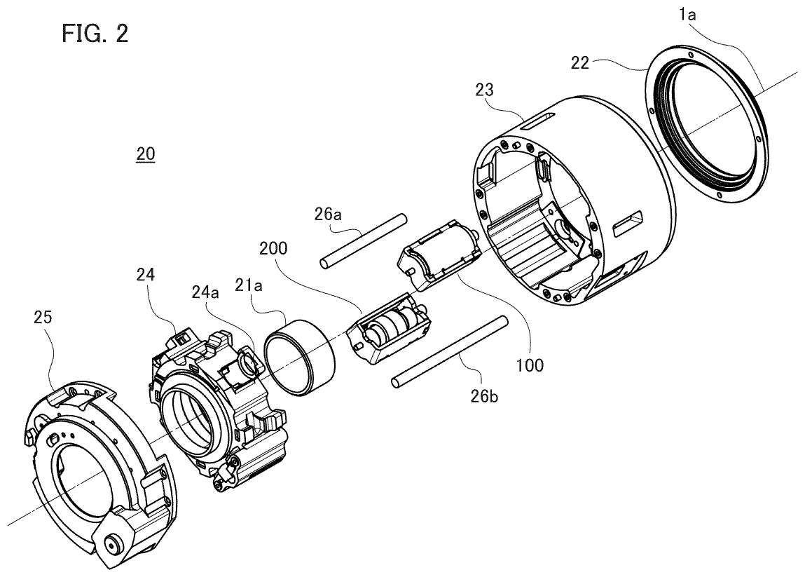

FIG. 2 is an exploded perspective view of the interchangeable lens 20 including the linear actuator according to the first embodiment. In the interchangeable lens 20, an exterior member is illustrated (an internal section is partially illustrated) as an outer shape in FIG. 1, the exterior member is not illustrated in FIG. 2 and subsequent drawings), and internal functional components are illustrated and described. An example in which the linear actuator according to the present embodiment is applied to a focus unit will be described below.

In FIG. 2, reference signs 100 and 200 denote the linear actuators according to the present embodiment. The linear actuators are arranged such that a main axial direction which is a driving direction substantially matches the direction of the optical axis 1a, and each linear actuator includes a magnetic field portion including coils, a permanent magnet group, and a yoke group.

In FIG. 2, reference sign 23 denotes a focus unit case, reference sign 24 denotes a lens holder, reference sign 25 denotes a focus unit cover, and reference signs 26a and 26b denote a guide bar. The focus unit case 23 includes a position sensor (not illustrated) for detecting an amount of movement of the focus lens group 21a or a flexible printed circuit board.

The focus unit case 23 is directly or indirectly fixed to a mount component 22 and holds other unit components. The focus unit case 23 according to the present embodiment has an internal shape corresponding to the external shape of the interchangeable lens 20 which has a cylindrical shape and has a cylindrical shape.

The focus unit case 23 is formed of a material with good balance between weight and strength such as a fiber-reinforced resin or a die-cast alloy. In the focus unit case 23, two metallic guide bars 26a and 26b are arranged with a predetermined gap therebetween in a posture in which both are substantially parallel to the optical axis 1a, and ends thereof are fitted and fixed.

For example, various methods of press-fitting or bonding are used as the fixing method at that time. The guide bars 26a and 26b serve to support the lens holder 24 holding the focus lens group 21a to be linearly movable in the direction of the optical axis 1a (such that a degree of freedom is 1). That is, unnecessary movement such as translation in a direction perpendicular to the optical axis 1a, pitching, yawing, or rolling is regulated.

The focus unit cover 25 is attached to the focus unit case 23, and the other ends of the two guide bars 26a and 26b are fitted and fixed to the focus unit cover 25. Accordingly, since the two guide bars 26a and 26b are double-supporting guide bars, the focus lens group 21a can be driven with high precision and with high rigidity.

The lens holder 24 is a component holding the focus lens group 21a and includes two fitting portions corresponding to the two guide bars 26a and 26b.

These fitting portions are constituted by sliding portions, slide bearings, or rolling portions and have a configuration in which a reaction in a direction other than the linear moving direction with respect to the guide bars 26a and 26b is small and resistance such as wear is reduced. The lens holder 24 is formed of, for example, a fiber-reinforced resin.

The lens holder 24 further includes coil holding portions 24a and 24b (24b is not illustrated). Coils of the linear actuators 100 and 200 are fixed to the coil holding portions 24a and 24b, for example, by bonding. Accordingly, the lens holder 24 and the focus lens group 21a which are driven portions are driven by receiving outputs of the linear actuators 100 and 200.

The other magnetic field portions of the linear actuators 100 and 200 are fixed to the focus unit case 23 by locking members such as screws. Accordingly, a driving force is transmitted from a fixed portion including the focus unit case 23 and the mount component 22 to the lens holder 24 by the linear actuators 100 and 200, and the focus lens group 21a is driven.

In this way, the linear actuators 100 and 200 according to the present embodiment are set as a so-called moving coil type in which the magnetic field portions are used as a fixed side and the coils are used as a movable portion. This is because the coils are lighter than the magnetic field portion in the linear actuators and thus moving performance or power saving performance is likely to be enhanced by reducing the mass of the movable portion.

On the other hand, in a moving magnet type in which the magnetic field portions are used as the movable portion and the coils are used as a fixed side, for example, a wiring portion is not used as the movable side, and thus there is an advantage that reliability is likely to be enhanced. The linear actuator according to the present embodiment can be applied to any type.

The linear actuators 100 and 200 according to the present embodiment are direct-current linear DC motors (LDM) which are a kind of electromagnetic linear motor. The LDM has characteristics capable of controlling a minute force regardless of a position or a speed and can be suitably used for a driving means for various types of positioning including the focusing mechanism in the present embodiment.

The interchangeable lens 20 according to the present embodiment includes two linear actuators for driving the focus lens group 21a. Since the coils are fixed to the same lens holder 24, outputs of the two linear actuators act in parallel.

Accordingly, it is possible to drive the focus lens group 21a with a large mass. By decreasing limitation to the mass of the focus lens group 21a, limitation of the optical configuration of the lens group 21 is decreased, and performance improvement such as an additional increase in precision or a decrease in size of the interchangeable lens 20 is decreased. Accordingly, two or more linear actuators may be used in the interchangeable lens of the camera system.

A more detailed configuration of the linear actuators 100 and 200 will be described below. Since the linear actuators 100 and 200 in the present embodiment have the same configuration, only the linear actuator 100 is illustrated and described.

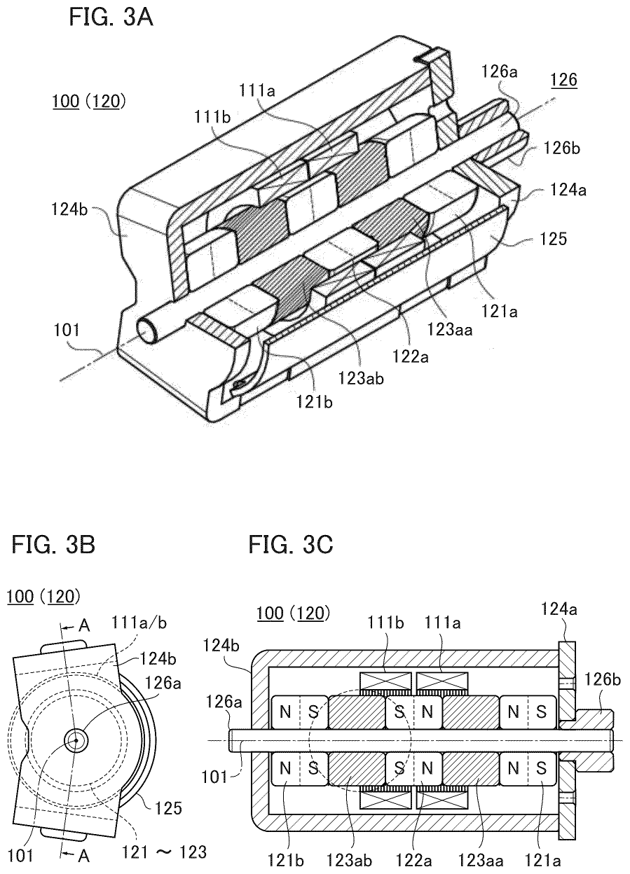

FIGS. 3A to 3C are schematic diagrams illustrating the configuration of the linear actuator 100 according to the first embodiment. FIG. 3A is an isometric vice with a partial cross-section, FIG. 3B is a front view, and FIG. 3C is a side sectional view.

In FIGS. 3A to 3C, reference sign 101 denotes a main axis, reference signs 111a and 111b denote coils, and reference sign 120 denotes a magnetic field portion other than the coils. The magnetic field portion 120 includes a plurality of permanent magnets, yoke components formed of a magnetic material, and skewers mainly formed of a nonmagnetic material. As illustrated in FIG. 3A, a multipolar magnet in which a plurality of magnets are arranged in series is used in the present embodiment.

Reference signs 121a, 121b, and 122a denote thrust mono-polarized ring magnets, reference signs 123aa and 123ab denote inner ring yokes corresponding to an inner yoke, reference signs 124a and 124b denote outer yokes, and reference sign 125 denotes a cover yoke. Reference signs 126a and 126b denote a skewer 126 together.

The thrust ring magnets 121a, 121b, and 122a are monopolar permanent magnets magnetized in the center axis direction (thrust mono-polarized ring magnets) having a ring shape. A thrust ring magnet is manufactured, for example, by sintering and pressing a magnetic material in a magnetic field or by removing and machining a sintered base material.

Reasons the ring-shaped magnets are used are that the magnets can be easily manufactured, the coils to be combined can be easily manufactured, and the combinations can be easily lay out. The linear actuator according to the present embodiment may employ magnets of another shape.

Various yoke components 123aa, 123ab, 124a, 124b, and 125 serve to pass a large amount of magnetic fluxes which are important for the magnetic field portion of the linear actuator and thus are formed of a magnetic material such as pure-iron steel or magnetic stainless steel with high magnetic permeability.

The skewer 126 penetrates inner openings corresponding to inner open regions of the thrust ring magnets 121a, 122a, and 121b and the inner ring yokes 123aa and 123ab to support them. Accordingly, these components can be easily bound and fixed in the magnetic field portion 120.

In the skewer 126, reference sign 126a denotes a shaft which is a main shaft portion, and reference sign 126b denotes an end component of one end. The shaft 126a and the end component 126b are strongly fixed to each other, for example, by press-fitting to constitute the skewer 126.

Here, in order to prevent a decrease in efficiency due to leakage of a magnetic flux on the inner side of the thrust ring magnets 121a, 122a, and 121b, the shaft 126a penetrating them is formed of, for example, a copper-based or aluminum-based material which is a nonmagnetic material. On the other hand, the end component 126b of the skewer 126 is formed of a magnetic material.

Details of the components will be described below. First, a main axis 101 is illustrated such that a direction at each stroke position matches a direction of a thrust and the position is located at an arbitrary reference position for the purpose of convenience.

For example, in the linear actuator 100 according to the present embodiment, the main axis 101 is located at a winding core position of the coils or on a center axis of the thrust ring magnets 121a, 121b, and 122a and the inner ring yokes 123aa and 123ab which is the same axis as the winding core position.

Since the direction of a thrust in the linear actuator 100 is basically constant regardless of a stroke position, the main axis 101 is basically a linear shape. The configuration of the present embodiment may be applied to a linear actuator including a main axis of a slow curved shape.

In the linear actuator 100 according to the present embodiment, the main axis 101 is considered as a reference axis of an ideal reference straight line. The winding core of the coils 111a and 111b and the center axis of the thrust ring magnets 121a, 121b, and 122a and the inner ring yokes 123aa and 123ab are disposed together with respect to the main axis 101.

For example, it is assumed that an interlinkage flux density distribution for generating a Lorentz force corresponding to the thrust in the coils 111a and 111b is distributed uniquely or symmetrically around the winding core. In this case, operating points of the thrust in strokes of the linear actuator 100 theoretically match on the main axis 101 located at the winding core position of the coil 111.

On the other hand, when the interlinkage flux density distribution is not uniquely or symmetrically, the operating points are displaced from the main axis 101, and an amount of displacement thereof is generally small. Accordingly, when it is intended to use the linear actuator 100, a layout can be made by considering the main axis 101 as a practical operating position of the thrust.

The coils 111a and 111b are coils which are formed by winding a conductor wire with an insulating coating such as a so-called enameled wire around a winding core and solidifying the conductor wire using an adhesive or the like and are air-core coils having an opening in a winding core portion.

The coils 111a and 111b have a solenoid coil shape in which a winding shape (a cross-sectional shape with respect to the winding core) is circular. A coil of this shape can be easily manufactured, and precision of an inner radial shape can be easily enhanced. Here, the linear actuator according to the present embodiment may employ coils of other winding shapes (for example, a rectangular shape or an elliptical shape).

Since the linear actuator according to the present embodiment is an actuator in which the magnetic field portion has multiple poles, the linear actuator 100 includes two coils to acquire a stable thrust at any stroke position as a result.

The two coils move as a coil body into which the two coils are unified through bonding or the like. That is, the coil body according to the present embodiment has a configuration in which two or more coils relatively movable in the arrangement direction of the multipolar magnet are bound. Control for changing current-supply proportions to the coils according to the magnetic field acting on the coils is performed at each stroke position. Details of this control will be described later.

The thrust ring magnets 121a, 121b, and 122a are periodically arranged in the direction of the main axis 101 in the internal opening area of the coils 111a and 111b. That is, the thrust ring magnet 121a and the thrust ring magnet 122a are sequentially arranged, and then the thrust ring magnet 121b is arranged again.

In the present embodiment, an example of a configuration of magnet arrangement corresponding to 1 and ¼ periods is described, and the number of ring magnet groups may be increased to increase the period. As a result, it is possible to extend a stroke of the linear actuator.

The thrust ring magnets 121a, 121b, and 122a have substantially the same outer shape in a direction perpendicular to the main axis 101. That is, the outer diameters of the ring shapes are substantially equal. This outer diameter is slightly smaller than the inner diameter of the coils 111a and 111b and has a predetermined clearance from the coils 111a and 111b. Accordingly, the coil body can move relatively with respect to the arrangement direction of the ring magnet groups without contact therewith.

The thrust ring magnets 121a and 121b and the thrust ring magnet 122a have main magnetization directions which are opposite to each other in the direction of the main axis 101. The inner ring yokes 123aa and 123ab are added to the periodic arrangement of the ring magnet groups.

The thrust ring magnets 121a, 121b, and 122a and the inner ring yokes 123aa and 123ab cause an interlinkage flux which is an effective magnetic flux for generating a Lorentz force of the coils 111a and 111b corresponding to the thrust in the linear actuator 100.

As described above, in the present embodiment, the multipolar magnet is configured by directly or indirectly connecting a plurality of magnets and has a yoke disposed between the plurality of magnets.

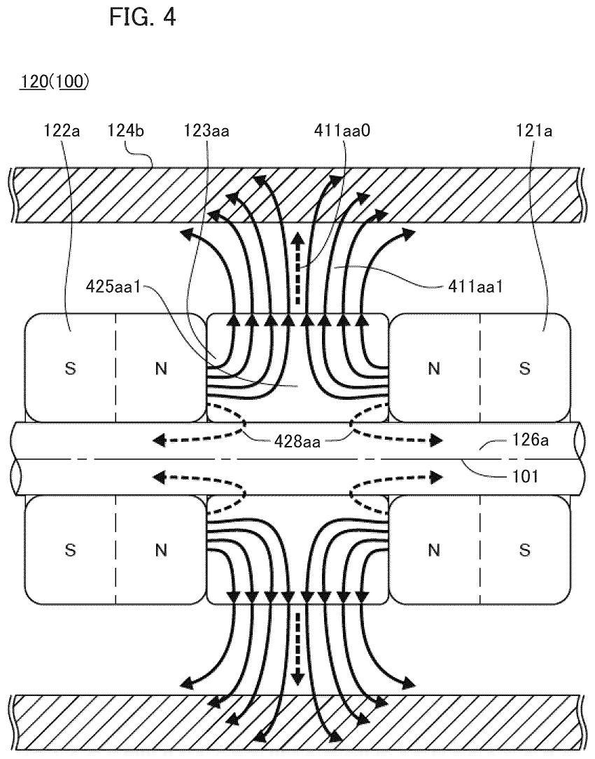

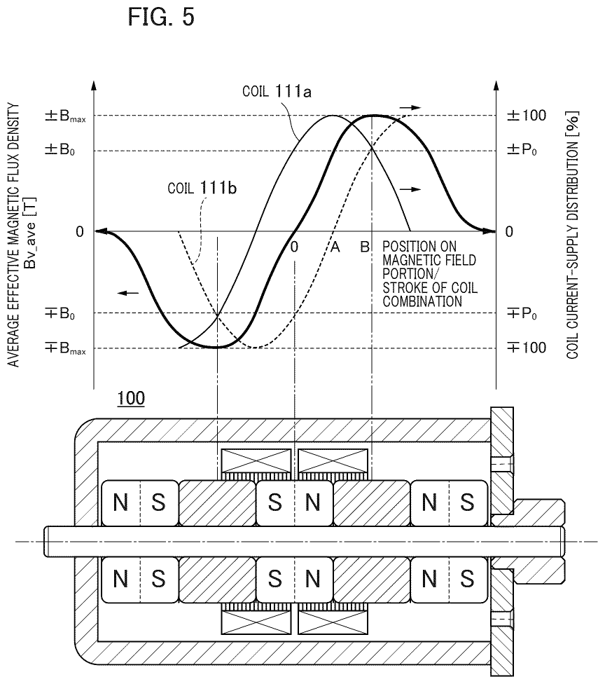

Control for changing current-supply proportions to coils will be described below with reference to FIGS. 4 and 5. FIG. 4 is a diagram illustrating magnetic fluxes in the magnetic field portion 120 of the linear actuator 100 according to the embodiment.

In FIG. 4, a part of a side sectional view of the magnetic field portion 120 is enlarged, and peripheral parts of the thrust ring magnet 121a, the inner ring yoke 123aa, and the thrust ring magnet 122a are representatively illustrated.

In FIG. 4, only magnetic fluxes in an upper half of the sectional view are drawn out and referred to by reference signs for magnetic fluxes, and the same is true of the magnetic fluxes in a lower half (both are in areas on the same cylindrical surface). In FIG. 4, sectional hatches of a permanent magnet and an inner yoke are not illustrated for the purpose of convenience of illustration.

The direction of the interlinkage flux of the coils 111a and 111b which is an effective magnetic flux in the linear actuator 100 is denoted by 411aa0 and, that is, corresponds to a radial direction in a cylindrical coordinate system centered on the main axis 101.

On the other hand, since the thrust ring magnet 121a and the thrust ring magnet 122a are arranged such that the same poles (N poles in the drawing) are opposite to each other in the direction of the main axis 101, magnetic fluxed therebetween are denoted by 425aa1 and 425aa1.

First, the magnetic fluxes output in the direction of the main axis 101 repulse each other, turn in a direction perpendicular to the main axis 101, and are discharged to the outer coil portions in a state in which the component in the interlinkage flux direction 411aa0 has been increased.

The linear actuator 100 according to the present embodiment includes the shaft 126a which is a skewer penetrating and binding the ring magnet group and the inner ring yoke group, which can be formed of a nonmagnetic material.

This is for reducing non-effective magnetic fluxes discharged to the inside of the magnets indicated by 428aa as much as possible. That is, since this non-effective magnetic fluxes are generated because the permanent magnet has a ring shape having an opening therein, the non-effective magnetic fluxes can be reduced by decreasing magnetic permeability of that portion.

Since it is also effective to reduce an opening shape, the inner diameter of the ring magnet group and the inner ring yoke group and the outer diameter of the skewer can be as small as possible in a range in which the skewer satisfies necessary strength.

The linear actuator according to the present embodiment can be constituted by only the aforementioned arrangement of the ring magnet group and the inner ring yoke group. However, the linear actuator 100 according to the present embodiment includes outer yokes 124a and 124b and a cover yoke 125 as constituents for further enhancing efficiency.

These constituents are configured to cover all or some of the ring magnet group and the inner ring yoke group from the outside of the coils 111a and 111b in the direction perpendicular to the main axis 101. Accordingly, the outer yokes 124a and 124b and the cover yoke 125 serve to apparently absorb the magnetic fluxes 425aa1 and 411aa1 of the ring magnet group illustrated in FIG. 4 in the interlinkage flux direction 411aa0 and serve to strengthen components in that direction.

The outer yoke 124a is a plate-shape component which is formed, for example, press-punching a pure-iron steel plate. The outer yoke 124a includes screw holes for fixation to the focus unit case 23, fitting holes for axially supporting the skewer 126 binding the ring magnet group and the inner ring yoke group, and fitting portions for fitting to the outer yoke 124b. The outer yoke 124a serves as a fixation reference portion in the linear actuator 100.

The outer yoke 124b is, for example, a component which is formed by press-punching and bending a pure-iron steel plate. The outer yoke 124b includes fitting portions which are fitted to the outer yoke 124a and a fitting hole for axially supporting the skewer 126. The outer yoke 124b is unified with the outer yoke 124a and stably supports the skewer 126 in a double-supporting manner.

As described above, the skewer 126 is used to improve convenience in assembly of a linear actuator or assembly of a device by penetrating and binding the ring magnet group and the inner yoke group.

That is, the linear actuator can be assembled by causing the skewer 126 to sequentially penetrate the ring magnet group and the inner yoke group. Since the skewer fixes these components, a step of fixing the components, for example, by bonding can be omitted.

When the linear actuator is combined into a device, the skewer protrudes from an outer shape, and simple and high-precision positioning can be performed using an end of the protruding skewer as an introduction or positioning boss.

In the skewer 126, the shaft 126a is formed of a nonmagnetic material as described above, and the end component 126b at one end is formed of a magnetic material. This is for stably constructing the magnetic field portion 120 of the linear actuator 100 using its own magnetic force.

In the present embodiment, since the magnets in which the same poles face each other and the yokes are coupled, a stroke length can be greatly increased by increasing the number of magnets and yokes to be coupled. Since the thrust at a stroke end is less likely to decrease and a long stroke can be realized, the linear actuator according to the present embodiment can be suitably applied to a lens with a long stroke for focus or zoom.

FIG. 5 is a diagram illustrating an example of a coil current-supply control method for generating the thrust of the linear actuator 100. In FIG. 5, an example of current-supply distribution proportions to two coils 111a and 111b for causing the thrust efficiency of the linear actuator 100 to be constant regardless of the stroke position is illustrated.

The horizontal axis in the graph illustrated in FIG. 5 represents a position in the direction of the main axis 101 on the magnetic field portion 120 or a stroke position of the combination of the two coils 111a and 111b (hereinafter referred to as a coil body).

The center position of the magnetic field portion in the schematic state of the linear actuator 100 and the center position of the coil body illustrated in the lower part of FIG. 5 are set as a zero position serving as a reference. The vertical axis (the left) of FIG. 5 represents an average effective magnetic flux density at a position on the magnetic field portion and represents a magnetic phase with respect to a position in the direction of the main axis 101 on the magnetic field portion 120. The vertical axis (the right) represents a current-supply distribution proportion to the coils 111a and 111b at a stroke position of the coil body.

In the linear actuator 100 according to the present embodiment, a stroke position of the coil body is detected by a position sensor for driving control which is not illustrated. That is, in the present embodiment, a position sensor detecting a position of the coil body in the arrangement direction of the multipolar magnet is provided.

The linear actuator 100 according to the present embodiment includes a current-supply control means controlling currents supplied to the coils on the basis of the position of the coil body detected by the position sensor. That is, the current-supply distribution proportions to the coils are changed and controlled by a current-supply control circuit (the current-supply control means) which is not illustrated on the basis of signs and a relative magnitude relationship of average effective magnetic flux densities at the positions of the coils.

For example, when the stroke position of the coil body is the zero position, the average effective magnetic flux densities in the coils 111a and 111b have opposite directions and substantially the same magnitude (an absolute value B₀ [T] in FIG. 5). Accordingly, the current-supply distribution proportions to the coils are set to have the opposite signs and substantially the same magnitude (an absolute value P₀ [%] in the drawing).

On the other hand, for example, when the stroke position of the coil body is a position A, the average effective magnetic flux density in the coil 111a is maximized (an absolute value Bₘₐₓ [T] in the drawing). Since the average effective magnetic flux density in the coil 111b is almost zero, only the coil 111a is supplied with a current at a maximum proportion corresponding to the average effective magnetic flux density.

The proportion at this time is set to, for example, a value with which electric power consumed in the coil 111a becomes substantially equal to a total value of electric power consumed in two coils when the stroke position of the coil body is the zero position (an absolute value 100 [%] in the drawing).

When the stroke position of the coil body is a position B, the average effective magnetic flux densities in the coils 111a and 111b have the same direction and substantially the same magnitude (an absolute value B₀ [T] in the drawing). Accordingly, the current-supply distribution proportions to the coils are set to have the same sign and substantially the same magnitude. The proportions at this time are substantially the same as the proportions when the stroke position of the coil body is the zero position (an absolute value P₀ [%] in the drawing).

The aforementioned example represents the current-supply distribution proportions to the coils for acquiring thrusts with the same direction and the same magnitude using substantially the same electric power at any stroke position when the winding directions of the coils 111a and 111b are the same. As the average effective magnetic flux densities at the coil positions, values at the center positions of the coils in the direction of the main axis 101 are considered.

As described above, it is possible to generate a thrust in the direction parallel to the optical axis 1a using the linear actuator by supplying a current.

A method of generating a holding force acting in the direction perpendicular to the optical axis 1a will be described below.

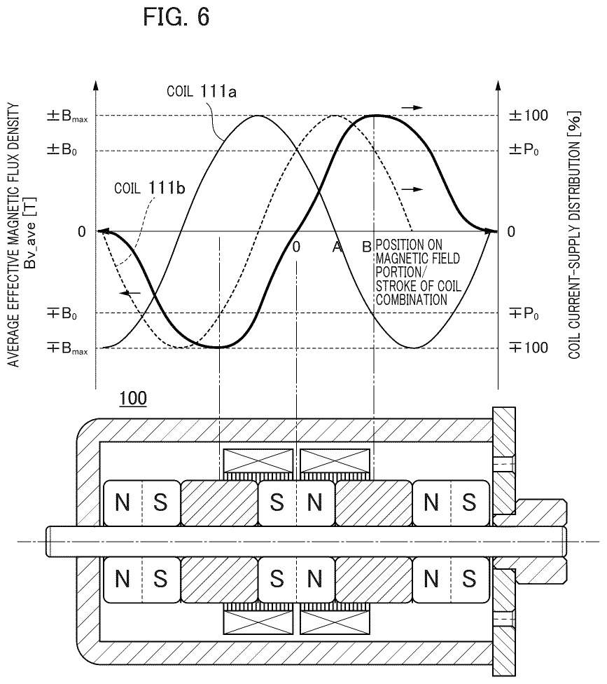

FIG. 6 is a diagram illustrating a coil current-supply control method for generating a holding force acting in the direction perpendicular to the optical axis 1a in the linear actuator 100 according to the first embodiment. In FIG. 6, an example of current-supply distribution proportions to two coils 111a and 111b for causing the linear actuator 100 to maintain a constant holding force regardless of the stroke position is illustrated.

In the graph illustrated in FIG. 6, similarly to the graph illustrated in FIG. 5, the horizontal axis represents a position in the direction of the main axis 101 on the magnetic field portion 120 or a stroke position of the coil body which is a combination of the two coils 111a and 111b. The center position of the magnetic field portion in the schematic state of the linear actuator 100 and the center position of the coil body illustrated in the lower part of the drawing are set as the zero position serving as a reference.

In the linear actuator 100, the stroke position of the coil body is detected by a position sensor for driving control which is not illustrated. The current-supply distribution proportions to the coils are changed and controlled by the current-supply control circuit on the basis of signs and a relative magnitude relationship of the average effective magnetic flux densities at the positions of the coils. Accordingly, it is possible to cause the coil body not to generate a thrust in the direction parallel to the optical axis 1a and to generate a holding force acting in the direction perpendicular to the optical axis 1a.

For example, when the stroke position of the coil body is the zero position, the average effective magnetic flux densities in the coils 111a and 111b have the opposite directions and substantially the same magnitude (the absolute value B₀ [T] in the drawing). Accordingly, the current-supply distribution proportions to the coils are set to have the same sign and substantially the same magnitude (the absolute value P₀ [%] in the drawing).

By employing these current-supply distribution proportions, an effective Lorentz force includes only a component of attraction such that the stroke position is the zero position, that is, a holding force. On the other hand, for example, when the stroke position of the coil body is the position A, the average effective magnetic flux density in the coil 111b is maximized (the absolute value Bₘₐₓ [T] in the drawing), and the average effective magnetic flux density in the coil 111a is almost zero.

Accordingly, only the coil 111b is supplied with a current at a maximum proportion corresponding to the sign of the average effective magnetic flux density. The proportion at this time is set to, for example, a value with which electric power consumed in the coil 111b becomes substantially equal to a total value of electric power consumed in two coils when the stroke position of the coil body is the zero position (the absolute value 100 [%] in the drawing).

When the stroke position of the coil body is the position B, the average effective magnetic flux densities in the coils 111a and 111b have the opposite directions and substantially the same magnitude (the absolute value B₀ [T] in the drawing). Accordingly, the current-supply distribution proportions to the coils are set to have the opposite signs and substantially the same magnitude. The proportions at this time are substantially the same as the proportions when the stroke position of the coil body is the zero position (the absolute value P₀ [%] in the drawing).

The aforementioned example represents the current-supply distribution proportions to the coils for acquiring a holding force using substantially the same electric power at any stroke position when the winding directions of the coils 111a and 111b are the same. As the average effective magnetic flux densities at the coil positions, values at the center positions of the coils in the direction of the main axis 101 are considered.

In FIGS. 5 and 6, the linear actuator 100 according to the present embodiment controls a current-supply phase to the coils 111a and 111b with respect to a magnetic phase of the magnetic field portion (the stroke position of the coil body). Accordingly, a phase difference between the magnetic phase and the current-supply phase can be controlled, and proportions of the thrust in the direction parallel to the optical axis 1a and the holding force in the direction perpendicular to the optical axis 1a can be controlled.

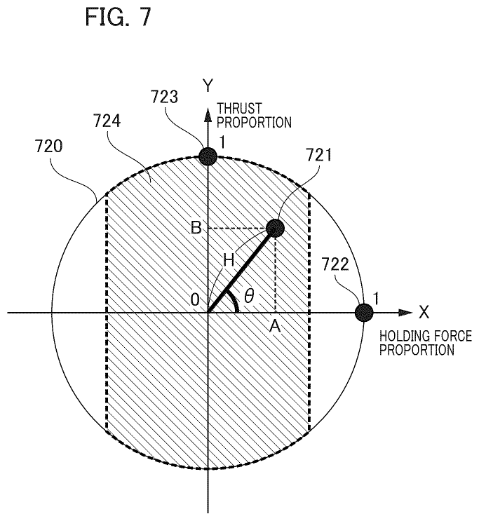

FIG. 7 is a diagram illustrating generation proportions of the thrust and the holding force which are generated according to the current-supply phase to the coils in a method of controlling the linear actuator according to the first embodiment. That is, FIG. 7 illustrates generation proportions of the thrust and the holding force which are generated according to the current-supply phase to the coils with respect to the magnetic phase of the magnetic field portion (the stroke position of the coil body) in the linear actuator 100. The horizontal axis (X axis) represents the holding force proportion, and the vertical axis (Y axis) represents the thrust proportion.

For example, at a point 721 in FIG. 7, an angle formed with respect to the X axis is θ, and a vector length is H. This point 721 represents a state in which the current-supply phase (the current-supply distribution proportions illustrated in FIG. 6 and a point 722 in FIG. 7) with respect to the magnetic phase with a holding force proportion of 1 and a thrust proportion of 0 is delayed by the current-supply phase θ and current supply with H times the amplitude is performed on the coil body. When this current supply is performed, the thrust proportion A and the thrust proportion B are generated in the movable portion.

When currents are supplied to the coils 111a and 111b at the current-supply distribution proportions and the current-supply phase illustrated in FIG. 6 with respect to the magnetic phase of the linear actuator 100, current supply is performed at the proportions indicated by a point 722 in FIG. 7. This is current supply with a thrust proportion of 0 and a holding force proportion 1. In this state, a thrust is not generated in the direction parallel to the optical axis 1a, and a holding force is generated in the direction perpendicular to the optical axis 1a. In this state, electric power efficiency is poor.

On the other hand, when currents are supplied to the coils 111a and 111b at the current-supply distribution proportions and the current-supply phase illustrated in FIG. 5 with respect to the magnetic phase of the linear actuator 100, current supply indicated by a point 723 in FIG. 7 is performed. This is current supply with a thrust proportion of 1 and a holding force proportion of 0.

At this time, current supply in which the current-supply phase is delayed, for example, by 90° from the current supply with a thrust proportion of 0 and a holding force proportion of 1 illustrated in FIG. 6, and a thrust is generated in the direction parallel to the optical axis 1a. In this case, a holding force in the direction perpendicular to the optical axis 1a is not generated.

In the present embodiment, a range 724 which is hatched in FIG. 7 is a range in which the stroke position of the coil body can be held with high electric power efficiency by controlling the current-supply phases to two coils 111a and 111b with respect to the magnetic phase.

That is, in the linear actuator 100 according to the present embodiment, the current-supply control circuit controls a phase difference between the magnetic phase of the multipolar magnet and the current-supply phase to the coil body in a predetermined range. The range 724 is a range in which the holding force proportion is equal to or less than a predetermined value less than 1 in FIG. 7.

In this way, the proportions of the thrust which is a force in the arrangement direction of the coil body relatively movable and the holding force which is a force in the direction perpendicular to the arrangement direction are controlled. The current-supply control circuit (the current-supply control means) which is not illustrated according to the present embodiment includes a CPU which is a computer. The constituent means of the linear actuator can be controlled by the computer by causing the CPU to execute a computer program stored in a memory which is a storage medium.

Through control in this range, it is possible to realize holding of the stroke position of the coil body while reducing the power consumption in comparison with control in the related art. That is, the range 724 in the present embodiment is a range in which the holding force proportion is less than 1 and the thrust proportion is 1.

In the related art, the stroke position is normally sensed and a direction and a magnitude of the thrust in the driving direction are controlled on the basis of the sensed position in order to maintain the stroke position of the coil body in the LDM. This corresponds to supply of currents to the coils 111a and 111b at the current-supply distribution proportions illustrated in FIG. 5 in the linear actuator 100 according to the present embodiment, and this corresponds to the current-supply phase at the point 723 in FIG. 7.

FIG. 5 illustrates the current-supply distribution proportions to the coils for acquiring a thrust of the same direction and magnitude using substantially the same electric power at any stroke position when the winding directions of the coils 111a and 111b are the same.

In the related art, control for maintaining the stroke position is performed using the current-supply phase to the coils for acquiring a thrust in the direction opposite to the optical axis 1a along with the current-supply distribution proportions illustrated in FIG. 5. When this control is performed, there is a problem in that current supply is normally performed at a point on a circumference 720 in FIG. 7 and thus much electric power is consumed.

On the other hand, the linear actuator 100 according to the present embodiment can generate the holding force as illustrated in FIG. 6. Accordingly, when it is intended to maintain the stroke position, it is not necessary to control the thrust in the driving direction as in the related art.

For example, currents have only to be supplied to the coils 111a and 111b at the current-supply phase on the X axis in the range 724 and current supply is performed at the proportions at a point inside of the circumference 720, and thus it is possible to realize driving with high efficiency in which power consumption has been curbed. The current supply at only one point on the X axis in the range 724 is not performed, but the current-supply proportions may transition in a timer series to several points in the range 724 according to the situation of the linear actuator 100.

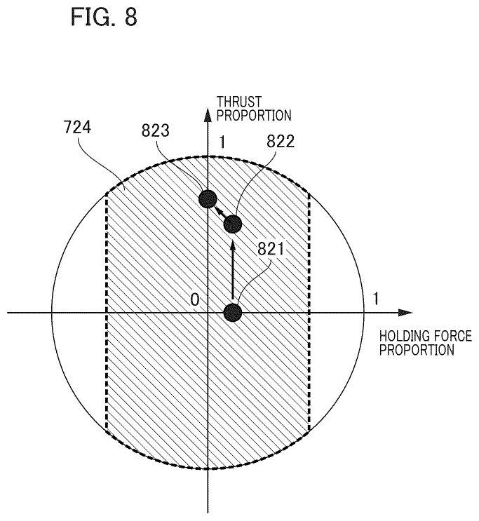

FIG. 8 is a diagram illustrating an example of transition in a time series of the current-supply phase to the coils for position holding according to the first embodiment. FIG. 8 illustrates an example in which the current-supply proportions transition in a time series to several points in the range 724. That is, it is assumed that it is intended to maintain the movable portion at a certain position in the linear actuator 100.

First, current supply is performed at the current-supply phase of a point 821. The point 821 does not include a thrust and includes only a holding force. However, since the holding force at the point 821 is small, the power consumption is small, but the position of the movable portion may not be able to be maintained.

Accordingly, the current-supply phase transitions to a point 822, and position holding is performed using a thrust together. However, when a thrust is used to a certain extent as at the point 822, the position can be held by appropriately controlling the direction of the thrust, and thus electric power corresponding to the holding force is useless. Accordingly, the current-supply phase transitions finally to a point 823, and the position is held using only the thrust.

By causing the current-supply phase in the range 724 to transition in a time series in this way, the phase difference between the magnetic phase and the current-supply phase transitions in a time series. Accordingly, it is possible to hold a position with high efficiency using power consumption which is less than that in the case in which the position holding is performed at only one point of the point 723 in FIG. 7.

Accordingly, for example, even when vibration which is generated when a mechanical shutter mechanism or the like mounted in the camera body 10 is driven propagates to the linear actuator 100 via the mount components 12 and 22, it is possible to hold a predetermined stroke position with high efficiency using low power consumption.

The range 724 in FIGS. 7 and 8 is an example of a range in which the current-supply phase is controlled, and the present embodiment is not limited to the size or shape of the range 724 illustrated in FIGS. 7 and 8 as long as it is a predetermined range in which the proportions of the thrust and the holding force can be arbitrarily changed.

The present embodiment is also useful in constant-speed driving. In the driving method of driving the linear actuator 100 at the same current-supply distribution proportions as illustrated in FIG. 5, only the thrust in the direction parallel to the optical axis 1a is generated in the linear actuator 100.

Accordingly, the size and direction of the thrust need to be finely controlled at the time of constant-speed driving, and it is difficult to accurately hold a constant speed particularly at the time of low-speed driving in an environment in which the posture of the linear actuator 100 varies from time to time.

On the other hand, in the present embodiment, the holding force in the direction perpendicular to the optical axis 1a can be used in addition to the thrust, and proportions thereof can be arbitrarily changed. Accordingly, even in an environment in which the posture of the linear actuator 100 changes, variation of the position is small, and the constant-speed driving can be performed with higher precision. The range 724 illustrated in FIG. 7 is set to a range in which the holding force proportion is equal to or less than a predetermined value in order to simultaneously generate the holding force and the thrust in this way.

In the present embodiment, the shape of the permanent magnet is a ring shape, but another shape may be used. The permanent magnet is not a single permanent magnet, and a plurality of permanent magnets may be combined.

The magnetic field portion 120 is not limited to the configuration in which the inner ring yokes are arranged in the ring magnet group, and may include only the magnet group. The multipolar magnetic field portion may be formed, for example, in a plate shape. In this case, a small magnetic field portion can be formed in the direction perpendicular to the optical axis 1a, but the yokes may not be formed in the magnet arrangement direction, which decreases ripples of a thrust.

In the present embodiment, the multipolar magnet (the ring magnet group) is used as a stator and the coil body is used as a rotor, but the multipolar magnet (the ring magnet group) may be used as a rotor and the coil body may be used as a stator. In this case, the position sensor detects a position of the multipolar magnet. That is, the position sensor has only to detect a relative position between the multipolar magnet and the coil body.

The proportions of the thrust and the holding force may be changed only at the timing at which disturbance is assumed to be mixed. Accordingly, it is possible to avoid lack of a thrust when it is necessary and non-attainment of target driving.

Examples of the timing at which disturbance is assumed include a timing at which a mechanical shutter mechanism is driven, a timing at which a mechanical aperture mechanism is driven, and a timing at which a posture of a camera varies due to a shake or the like.

### Second Embodiment

A linear actuator according to a second embodiment will be described below. In the second embodiment, the camera system 1 includes a hand-holding determination unit (a determination means). The hand-holding determination unit is mounted, for example, in the camera body 10 and determines whether the camera system 1 is hand-held or is fixed to a fixture such as a tripod on the basis of a signal from an acceleration sensor such as a gyro sensor of the camera body 10.

The determination means may determine whether a shake of an electronic device such as a camera body is equal to or greater than a predetermined value. Alternatively, the determination means may determine driving of a mechanical mechanism in an electronic device such as a camera body.

When the hand-holding determination unit determines that the camera system 1 is hand-held and is not fixed to a fixture or determines that a shake is large, a change in posture may affect constant-speed driving, and thus proportion control of a thrust and a holding force is performed.

On the other hand, when the hand-holding determination unit determines that the camera system 1 is fixed to a fixture or determines that a shake is not large, the proportion control of a thrust and a holding force is not performed, but current supply to the coils 111a and 111b is performed at the current-supply distribution proportions indicated by the point 723 in FIG. 7.

In this way, by performing the proportion control of a thrust and a holding force only when there is a likelihood that the posture of the camera will vary or a shake is large, it is possible to perform driving without consuming electric power in the holding force and unnecessarily decreasing the thrust and to perform driving with higher efficiency.

For example, a gyro sensor or the like may be mounted in the camera body 10 or may be mounted in the interchangeable lens 20. At least one of an output of a gyro sensor mounted in the camera body 10, an output of a gyro sensor mounted in the interchangeable lens 20, and a result of a blurring detection process on a video captured by the camera system 1 may be used as a signal used for hand-holding determination or shake determination.

The hand-holding determination unit has only to determine whether the posture of the camera can vary or a shake is large and may determine that the camera is hand-held when the camera is mounted in a mobile object such as a drone because there is a high likelihood that the posture of the camera will vary.

In this way, in the present embodiment, the hand-holding determination unit serves as a determination means determining a state of disturbance in the coil body. When occurrence of disturbance is predicted or detected by the determination means, a phase difference between the magnetic phase of the multipolar magnet and the current-supply phase to the coil body is controlled in a predetermined range by the current-supply control means.

The case in which occurrence of disturbance is predicted or detected by the determination means can include at least one of a case in which an electronic device such as a camera including the multipolar magnet and the coil body is not fixed, a case in which a shake of the electronic device is equal to or greater than a predetermined value, and a case in which a mechanical mechanism of the electronic device is driven.

The electronic device includes an imaging device such as a camera, and the mechanical mechanism includes a mechanical shutter mechanism or a mechanical aperture mechanism. The electronic device is not limited to imaging using a camera or the like, but may be, for example, a mobile object or a machine tool in which the linear actuator is mounted.

For example, when the posture of the camera may vary or when a shake of the camera is large, for example, the width in the X-axis direction of the range 724 may be enlarged. When the posture of the camera may vary or when a shake of the camera is large, the number of transition points in a process of transitioning to a plurality of points in the range 724 in a time series may be increased.

In the related art, when a shutter is driven in a steady state, a shutter shock of a high frequency is input and thus a target position may be shifted. When a user changes a posture during constant-speed driving, speed unevenness may occur. Particularly, in zooming, a frequency of posture change during driving is high. There is also a likelihood that electric power efficiency will decrease due to a process for curbing such an influence.

However, according to the present embodiment, even when there is disturbance, driving can be performed while maintaining a constant holding force, and thus it is possible to realize efficient position control or constant-speed driving with high precision while curbing power consumption.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-157497, filed Sep. 11, 2024, which is hereby incorporated by reference wherein in its entirety.

What is claimed is:

1. A linear actuator comprising:
a multipolar magnet in which a plurality of magnets are arranged in an arrangement direction;
a coil body in which two or more coils are bound;
a sensor detecting a relative position between the coil body and the multipolar magnet; and
a current-supply controller controlling currents supplied to the coils of the coil body on the basis of the relative position detected by the sensor,
wherein the coil body and the multipolar magnet are relatively movable with respect to each other in the arrangement direction, and
wherein the current-supply controller performs the control such that a phase difference between a magnetic phase of the multipolar magnet and a current-supply phase to the coil body is within a predetermined range, and the phase difference transitions in a time series.

2. The linear actuator according to claim 1, wherein the current-supply controller is constituted by a motor driver circuit.

3. The linear actuator according to claim 1, wherein the current-supply control ler controls a proportion of a thrust which is a force in the arrangement direction applied to the coil body and a holding force which is a force in a direction perpendicular to the arrangement direction by controlling the phase difference between the magnetic phase of the multipolar magnet and the current-supply phase to the coil body.

4. The linear actuator according to claim 1, further comprising a determination unit determining a state of disturbance in the coil body,
wherein the current-supply controller performs the control such that the phase difference between the magnetic phase of the multipolar magnet and the current-supply phase to the coil body is within the range in a case in which an occurrence of the disturbance is predicted or detected by the determination unit.

5. The linear actuator according to claim 4, wherein the case in which the occurrence of the disturbance is predicted or detected by the determination unit includes at least one of 1) a case in which an electronic device including the multipolar magnet and the coil body is not fixed, 2) a case in which a shake of the electronic device is equal to or greater than a predetermined degree, and 3) a case in which a mechanical mechanism of the electronic device is driven.

6. The linear actuator according to claim 5, wherein the electronic device includes an imaging device, and
wherein the mechanical mechanism includes a mechanical shutter mechanism or a mechanical aperture mechanism.

7. The linear actuator according to claim 1, wherein the multipolar magnet is configured by connecting the plurality of magnets.

8. The linear actuator according to claim 1, wherein the multipolar magnet includes a yoke which is disposed between the plurality of magnets.

9. The linear actuator according to claim 1, wherein the multipolar magnet is used as a stator and the coil body is used as a rotor.

10. The linear actuator according to claim 1, wherein the multipolar magnet is used as a rotor and the coil body is used as a stator.

11. A control method for controlling a linear actuator that includes:
a multipolar magnet in which a plurality of magnets are arranged in an arrangement direction;
a coil body in which two or more coils are bound; and
a sensor detecting a relative position between the coil body and the multipolar magnet,
the control method comprising:
controlling currents supplied to the coils of the coil body on the basis of the relative position detected by the sensor,
wherein the coil body and the multipolar magnet are relatively movable with respect to each other in the arrangement direction, and
wherein the controlling is performed such that a phase difference between a magnetic phase of the multipolar magnet and a current-supply phase to the coil body is within a predetermined range, and the phase difference transitions in a time series.

12. A non-transitory storage medium storing a program of a linear actuator that includes:
a multipolar magnet in which a plurality of magnets are arranged in an arrangement direction;
a coil body in which two or more coils are bound; and
a sensor detecting a relative position between the coil body and the multipolar magnet,
the program causing a computer to perform each step of a method for the linear actuator, the method comprising:
controlling currents supplied to the coils of the coil body on the basis of the relative position detected by the sensor,
wherein the coil body and the multipolar magnet are relatively movable with respect to each other in the arrangement direction, and
wherein the controlling is performed such that a phase difference between a magnetic phase of the multipolar magnet and a current-supply phase to the coil body is within a predetermined range, and the phase difference transitions in a time series.
